(19) United States
(12) Patent Application Publication
(10) Pub. No.: US 2026/0153234 A1
(43) Pub. Date: Jun. 4, 2026

(54) IGNITION, BURNING STABILIZATION, AND ENERGY CONSERVATION INTEGRATED WARM NUCLEAR FUSION AND PULVERIZED COAL COMBINED BURNING SYSTEM

(71) Applicant: Leading Guochuang (Beijing) Technology Group Co., LTD, Beijing (CN)

(72) Inventors: Enzhen Ding, Beijing (CN); Liwen Liu, Beijing (CN)

(21) Appl. No.: 19/392,223

(22) Filed: Nov. 18, 2025

(30) Foreign Application Priority Data
Aug. 21, 2025 (CN) 202511176788.6

(51) Int. Cl. F23D 1/02; F23K 3/02; G21B 3/00

(52) U.S. Cl. CPC F23D 1/02; F23K 3/02; F23D 2205/00; F23D 2207/00; G21B 3/00

(57) ABSTRACT

An ignition, burning stabilization, and energy conservation integrated warm nuclear fusion and pulverized coal combined burning system is provided, and relates to the field of burners. The system includes: a multi-stage pulverized coal burner which includes a stage-by-stage ignition tube and an elbow connected to a rear end of the stage-by-stage ignition tube. A wind-coal pipe is connected to another end of the elbow, and a coal taking opening is formed in one side of the wind-coal pipe. An inlet of a cyclone coal collector is connected to the coal taking opening, and a bottom outlet of the cyclone coal collector is connected to a combined burning torch. A front end of the grounding electrode is connected to the stage-by-stage ignition tube through a flame stabilization pipe. Efficient, stable, environmentally-friendly, and energy-saving operation of a power station boiler under a working condition of deep peak shaving can be implemented.

### TECHNICAL FIELD

The present disclosure relates to the field of burners, specifically to an ignition, burning stabilization, and energy conservation integrated warm nuclear fusion and pulverized coal combined burning system.

### BACKGROUND

According to the national policy requirements on cleanness and carbon reduction, photoelectricity, wind power, and hydropower are gradually increasingly used, and a thermal power station faces an intensified load in the deep peak shaving and the load variation rate. When a boiler load operates at 50% to 30%, a traditional power station boiler basically employs step-by-step ignition and gradual amplification for ignition and burning stabilization. Specifically, an oil gun ignition or an updated replacement technology such as a plasma arc ignition technology is used.

In terms of the oil gun ignition, micro-oil ignition is popular at present, and approximately 120 kg/h of diesel is used. However, due to the incomplete burning of the diesel, the oil gun ignition has low environmental protection. A flue gas dust removal bag is sticky, and even there is sometimes a fire. A very high requirement for on-site safety is put forward. Used coal is of poor quality, so that many power plants have to keep using a large oil gun for ignition.

In terms of the plasma arc ignition, a direct current plasma arc generator is mostly used at present. A direct current plasma arc column has a high temperature ranging from 3000° C. to 5000° C., and arc root spots have a higher temperature, which directly vaporizes electrode metals, so that it has to employ high-pressure water cooling on a negative electrode and a positive electrode. Consequently, the negative electrode has a lifespan of 80 to 100 hours, while the positive electrode has a lifespan shorter than 500 hours. Water leakage caused by electrode erosion occasionally occurs. As a result, a burner is severely coked. In extreme cases, the burner will be deadly blocked. Due to the deep peak shaving, the plasma arc generator has to start more frequently. At present, the power plant needs to replace an electrode tip once every three days, which not only significantly reduces the equipment reliability, but also increases the workload of workers. This further makes it harder to apply the plasma arc ignition technology, so that the power plant intends to cancel plasma ignition and reuse the oil gun ignition.

### SUMMARY

The present disclosure aims to provide an ignition, burning stabilization, and energy conservation integrated warm nuclear fusion and pulverized coal combined burning system, which integrates three functions of ignition, burning stabilization, and energy conservation, and can implement efficient, stable, environmentally-friendly, and energy-saving operation of a power station boiler under a working condition of deep peak shaving.

The embodiments of the present disclosure are implemented below:

An embodiment of the present disclosure provides an ignition, burning stabilization, and energy conservation integrated warm nuclear fusion and pulverized coal combined burning system, including a multi-stage pulverized coal burner, a wind-coal pipe, a combined burning torch, and a cyclone coal collector.

The multi-stage pulverized coal burner includes a stage-by-stage ignition tube and an elbow connected to a rear end of the stage-by-stage ignition tube; the wind-coal pipe is connected to another end of the elbow, and a coal taking opening is formed in one side of the wind-coal pipe;
an inlet of the cyclone coal collector is connected to the coal taking opening through a pulverized coal and air flow introduction pipe, and a bottom outlet of the cyclone coal collector is connected to the combined burning torch through a dense-phase pulverized coal guide pipe;
the combined burning torch includes an outer sleeve, a central wind-coal pipe, a multi-phase electrode combination, a grounding electrode, and a high-pressure air supply pipe; a front end of the outer sleeve is fixedly connected to the grounding electrode; the central wind-coal pipe is threaded into the outer sleeve and the grounding electrode in sequence, and a rear end of the central wind-coal pipe is connected to the high-pressure air supply pipe and the dense-phase pulverized coal guide pipe; the multi-phase electrode combination is equally threaded between the central wind-coal pipe and the outer sleeve and is connected to a multi-phase alternating current plasma power source, and a plurality of electrode tips of the multi-phase electrode combination are distributed inside an annular space between the grounding electrode and the central wind-coal pipe in an equal spacing manner; and a front end of the grounding electrode is connected to the stage-by-stage ignition tube through a flame stabilization pipe.

Further, based on the foregoing solution, a top of the cyclone coal collector is connected to a side wall of an upper part of the elbow through an exhaust gas conveying pipe; and the exhaust gas conveying pipe is provided with a variable-frequency induced draft fan.

Further, based on the foregoing solution, a sealed coal unloading valve, a pulverized coal falling pipe, and a pulverized coal ejector are connected between the bottom outlet of the cyclone coal collector and the dense-phase pulverized coal guide pipe in sequence.

Further, based on the foregoing solution, an exterior of the grounding electrode is cylindrical, and an interior of the grounding electrode is tapered and transitioned from a cylindrical shape into a plum blossom shape in a wind direction; the plurality of electrode tips are located inside a plurality of accommodating cavities of the plum blossom shape in a one-to-one correspondence manner; an end portion of the central wind-coal pipe close to the electrode tips is flared; and each electrode head is in a shape with a thin front part and a thick rear part.

Further, based on the foregoing solution, a spacing distance between the electrode tips and an inner wall of the grounding electrode, and a spacing distance between the electrode tips and the central wind-coal pipe are respectively 3 to 15 mm; and an air speed of the plasma carrier air is 15 to 35 m/s.

Further, based on the foregoing solution, a front end of the central wind-coal pipe is connected to a blunt cone; an outer diameter of the blunt cone is consistent with an outer diameter of the central wind-coal pipe; and a pointed end of the blunt cone is opposite to an axis of the central wind-coal pipe.

Further, based on the foregoing solution, the blunt cone is fixed at an end portion of the central wind-coal pipe through a supporting strip.

Further, based on the foregoing solution, the front end of the grounding electrode is connected to the flame stabilization pipe; the flame stabilization pipe is connected to the multi-stage pulverized coal burner; and a plurality of cyclone blades are respectively arranged on an inner wall of the flame stabilization pipe and an inner wall of the central wind-coal pipe that is close to the electrode tips in circumferential directions of the flame stabilization pipe and the central wind-coal pipe.

Further, based on the foregoing solution, a plurality of supporting spokes are uniformly distributed on an outer wall of the grounding electrode in a circumferential direction of the grounding electrode; and one end of the flame stabilization pipe is fixed on the supporting spokes.

Further, based on the foregoing solution, a cable junction box is arranged at one end of the outer sleeve that is away from the grounding electrode two glass observation holes are formed in an outer end surface of the cable junction box; and a cable outlet sealing sleeve is arranged on an annular side surface of the cable junction box.

Compared with the existing art, the embodiments of the present disclosure at least has the following advantages or beneficial effects:

In the present disclosure, dilute-phase pulverized coal fed into the wind-coal pipe is introduced from the coal taking opening through the pulverized coal and air flow introduction pipe into the cyclone coal collector for concentration, and concentrated dense-phase pulverized coal is supplied into the central wind-coal pipe along with high-pressure air of the high-pressure air supply pipe and is diffused and annularly sprayed through the blunt cone, so that the pulverized coal enters a low-temperature sliding plasma arc region in a dispersed manner. Meanwhile, a tapering spacing between the grounding electrode and the electrode tips ensures that the air speed of the plasma carrier is within an appropriate range, and quick ignition is implemented. After the pulverized coal is ignited, the fire gradually grows. The flames successively ignite the dilute- and dense-phase stage-by-stage ignition tube inside first to fifth stages of the multi-stage pulverized coal burner, thus ensuring ignition and burning stabilization of the entire pulverized coal entering a boiler. The present disclosure integrates three functions, i.e. ignition, burning stabilization, and energy conservation, and can implement efficient, stable, environmentally-friendly, and energy-saving operation of a power station boiler under a working condition of deep peak shaving.

### BRIEF DESCRIPTION OF THE DRAWINGS

For clearer descriptions of the technical solutions of the embodiments of the present disclosure, the accompanying drawings required to be used in the embodiments are briefly introduced below. It should be understood that the accompanying drawings below are only some embodiments of the present disclosure. Therefore, the embodiments shall not be regarded as limitations on the scope. A person of ordinary skill in the art can also derive other relevant drawings according to these drawings without creative work.

FIG. 1 is a schematic diagram of an entire structure of an ignition, burning stabilization, and energy conservation integrated warm nuclear fusion and pulverized coal combined burning system according to an embodiment of the present disclosure;

FIG. 2 is a sectional view of a combined burning system according to an embodiment of the present disclosure;

FIG. 3 is a schematic diagram of an external structure of a combined burning system according to an embodiment of the present disclosure;

FIG. 4 is a sectional view of a combined burning torch according to an embodiment of the present disclosure;

FIG. 5 is a partially schematic enlarged view of FIG. 4 according to an embodiment of the present disclosure;

FIG. 6 is a schematic structural enlarged view of a grounding electrode according to an embodiment of the present disclosure;

FIG. 7 is a rear-end view of a combined burning torch according to an embodiment of the present disclosure;

FIG. 8 shows pictures of plasma discharging of a 12 KW warm nuclear fusion and pulverized coal combined burning torch at different moments according to an embodiment of the present disclosure;

FIG. 9 shows infrared imaging pictures of plasma discharging of a 12 KW warm nuclear fusion and pulverized coal combined burning torch at different moments according to an embodiment of the present disclosure;

FIG. 10 shows pictures of 4500 kCal pulverized bituminous coal at 60 kg/kg at different moments of ignition according to an embodiment of the present disclosure; and

FIG. 11 shows pictures of 3500 kCal pulverized lignite at 60 kg/kg at different moments of ignition according to an embodiment of the present disclosure.

Reference numerals: 1: multi-stage pulverized coal burner; 11: stage-by-stage ignition tube; 12: elbow; 2: wind-coal pipe; 21: coal taking opening; 3: combined burning torch; 31: outer sleeve; 311: wear-resistant protective layer; 32: central wind-coal pipe; 321: thermal insulation layer; 33: multi-phase electrode combination; 331: electrode tip; 332: electrode stem; 333: first insulator; 334: second insulator; 335: pipe body; 34: grounding electrode; 341: supporting spoke; 35: high-pressure air supply pipe; 36: flame stabilization pipe; 37: blunt cone; 371: supporting strip; 38: cyclone blade; 39: cable junction box; 391: glass observation hole; 392: cable outlet sealing sleeve; 4: cyclone coal collector; 41: pulverized coal and air flow introduction pipe; 42: dense-phase pulverized coal guide pipe; 43: exhaust gas guide pipe; 44: exhaust gas lead-out pipe; 45: variable-frequency induced draft fan; 46: sealed coal unloading valve; 47: pulverized coal falling pipe; 48: pulverized coal ejector; 5: sliding rail; 6: supporting frame; 7: speed reducer; 8: electric controller; and 9: high-pressure fan.

### DETAILED DESCRIPTION OF THE EMBODIMENTS

The embodiments of the present disclosure are described in detail below with reference to the accompanying drawings in the embodiments of the present disclosure.

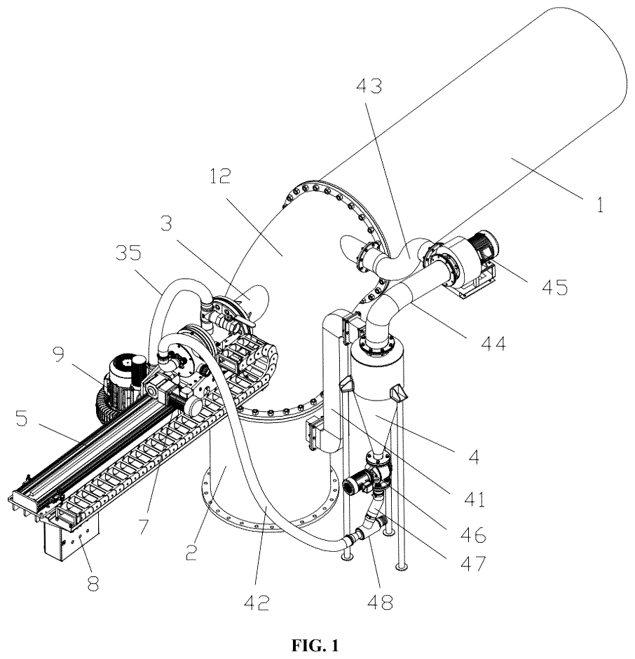

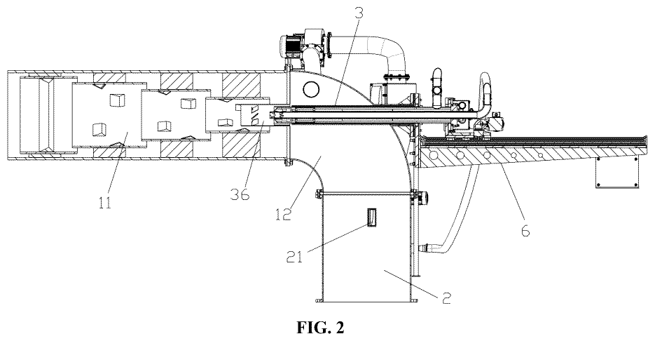

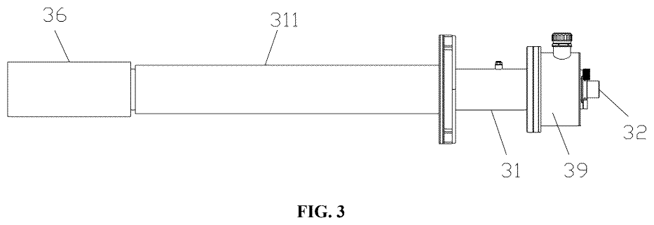

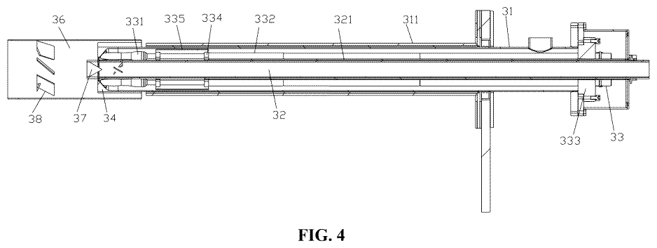

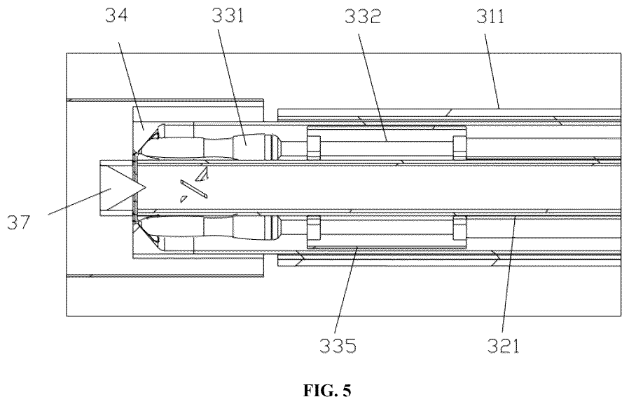

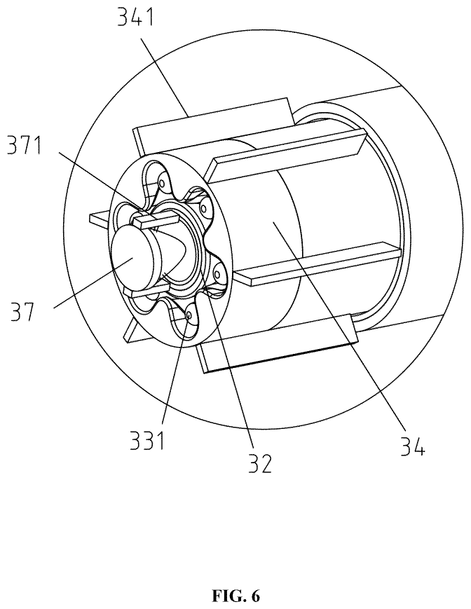

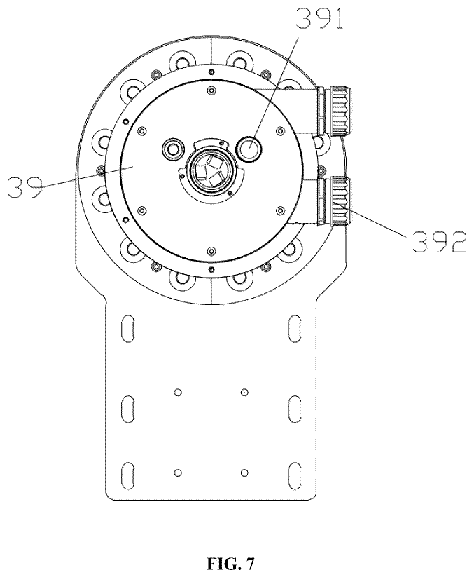

Referring to FIG. 1 to FIG. 11, a schematic diagram of an entire structure of an ignition, burning stabilization, and energy conservation integrated warm nuclear fusion and pulverized coal combined burning system is shown.

This embodiment provides an ignition, burning stabilization, and energy conservation integrated warm nuclear fusion and pulverized coal combined burning system, including a multi-stage pulverized coal burner 1, a wind-coal pipe 2, a combined burning torch 3, and a cyclone coal collector 4.

The multi-stage pulverized coal burner 1 includes a stage-by-stage ignition tube 11 and an elbow 12 connected to a rear end of the stage-by-stage ignition tube 11. The wind-coal pipe 2 is connected to another end of the elbow 12, and a coal taking opening 21 is formed in one side of the wind-coal pipe 2.

The combined burning torch 3 includes an outer sleeve 31, a central wind-coal pipe 32, a multi-phase electrode combination 33, a grounding electrode 34, and a high-pressure air supply pipe 35. A front end of the outer sleeve 31 is fixedly connected to the grounding electrode 34. The central wind-coal pipe 32 is threaded into the outer sleeve 31 and the grounding electrode 34 in sequence. A front end of the central wind-coal pipe 32 is connected to a blunt cone 37, and a rear end of the central wind-coal pipe 32 is connected to the high-pressure air supply pipe 35. A pointed end of the blunt cone 37 is opposite to an axis of the central wind-coal pipe 32. The multi-phase electrode combination 33 is equally threaded between the central wind-coal pipe 32 and the outer sleeve 31. A plurality of electrode tips 331 of the multi-phase electrode combination 33 are distributed inside the grounding electrode 34 in an equal spacing manner. A distance between the electrode tips 331 and the grounding electrode 34 gradually decreases in a wind direction.

An inlet of the cyclone coal collector 4 is connected to the coal taking opening 21 through a pulverized coal and air flow introduction pipe 41, and a bottom outlet of the cyclone coal collector 4 is connected to the central wind-coal pipe 32 through a dense-phase pulverized coal guide pipe 42.

The ignition, burning stabilization, and energy conservation integrated warm nuclear fusion and pulverized coal combined burning system of this exemplary embodiment is further described below.

In some implementations, the multi-stage pulverized coal burner 1 is in charge of a primary burning task, and includes the dilute- and dense-phase stage-by-stage ignition tube 11 and the elbow 12 connected to a rear end of the stage-by-stage ignition tube 11. The stage-by-stage ignition tube 11 is connected to the elbow 12 through a flange. The multi-stage pulverized coal burner 1 implements stage-by-stage burning of a dense phase and a dilute phase, and implements smooth transition from ignition to primary burning in conjunction with a low-temperature plasma region formed by the combined burning torch 3. The wind-coal pipe 2 is connected to another end of the elbow 12 through a flange, and the coal taking opening 21 is formed in one side of the wind-coal pipe 2. The wind-coal pipe 2 provides primary combustion-supporting air and a pulverized coal comburent for a burning reaction, and generally supplies the air and the comburent from its bottom.

The inlet of the cyclone coal collector 4 is hermetically docked through the pulverized coal and air flow introduction pipe 41 to the coal taking opening 21 formed in the wind-coal pipe 2, and the bottom outlet of the cyclone coal collector 4 is connected to the combined burning torch 3 through the dense-phase pulverized coal guide pipe 42. Generally, at the beginning of ignition of a power station boiler, dilute-phase pulverized coal that is provided by equipment such as a coal mill and has a coal-to-wind ratio of 0.2 kg/kg (every kg of air contains 0.2 kg of pulverized coal) is fed into the wind-coal pipe 2 at 18 m/s, so that it is very hard for ignition. In the present disclosure, by arranging, at a position close to the wind-coal pipe 2, one cyclone coal collector 4 docked to a side surface of the wind-coal pipe 2 and using the cyclone coal collector 4 to concentrate dilute-phase pulverized coal into dense-phase pulverized coal and feed it into the combined burning torch 3, the ignition efficiency is improved, and quick ignition is implemented. It should be noted that similar to that of an existing cyclone coal collector, the principle of the above cyclone coal collector 4 is to implement a pulverized coal concentration function, so that a concentration of pulverized coal inside the central wind-coal pipe 32 is increased by 2 to 5 times. This greatly improves the ignition efficiency and the flame stability, and low-quality coal can be directly ignited.

The combined burning torch 3 includes the outer sleeve 31, the central wind-coal pipe 32, the multi-phase electrode combination 33, the grounding electrode 34, and the high-pressure air supply pipe 35. The front end of the outer sleeve 31 is fixedly connected to the grounding electrode 34. The central wind-coal pipe 32 is threaded into the outer sleeve 31 and the grounding electrode 34 in sequence. The rear end of the central wind-coal pipe 32 is connected to the high-pressure air supply pipe 35 and the dense-phase pulverized coal guide pipe 42. The multi-phase electrode combination 33 is equally threaded between the central wind-coal pipe 32 and the outer sleeve 31 and is connected to a multi-phase alternating current plasma power source, and the plurality of electrode tips 331 of the multi-phase electrode combination are distributed inside the grounding electrode 34 in an equal spacing manner. The electrode tips 331 are made of a high-melting-point rare metal material. A front end of the grounding electrode 34 is connected to the stage-by-stage ignition tube 11 through the flame stabilization pipe 36. The multi-phase electrode combination 33 is preferably a six-phase electrode. An electrode stem 332 is sleeved with two layers of insulation pipes. The multi-phase electrode stem 332 is accurately, in parallel, and equally fixed and distributed in an annular space outside the central wind-coal pipe 32 and inside a sleeve through a first insulator 333 and a pipe body 335 with a second insulator 334.

The high-pressure air supply pipe 35 is connected to the high-pressure fan 9. High-pressure air that is generated by the high-pressure fan 9 and has a pressure of 0.3 to 0.8 MPa is ejected into the dense-phase pulverized coal guide pipe 42. In this case, dense-phase pulverized coal with a coal-to-wind ratio of 0.4 to 0.8 kg/kg at 15 to 20 m/s and 40 to 100 kg/h is fed into the central wind-coal pipe 32 of the warm nuclear fusion and pulverized coal combined burning torch 3 along with the high-pressure air and is sprayed out. The pulverized coal is fed into a sliding plasma arc region that is at the front end and has a low temperature of 150 to 300° C. After the pulverized coal is ignited, the fire gradually grows. The flames successively ignite the dilute- and dense-phase stage-by-stage ignition tube 11 inside first to fifth stages of the multi-stage pulverized coal burner 1, thus ensuring ignition and burning stabilization of the entire pulverized coal entering a boiler.

It should be noted that combined burning of the pulverized coal is implemented in a multi-phase high-frequency alternating current sliding plasma arc. This is actually a process of simultaneously burning deuterium-tritium fusion energy and chemical energy in the coal powder to release energy. Under a condition of outputting the same energy, 2% or more pulverized coal can be saved. Its principle is the disclosed existing art that has been described in many series patents of the inventor and is described in detail in the academic monograph Theory and Application of Controllable Warm Nuclear Fusion Accompanied by Photonuclear Reaction Burning published by the inventor, Xuzhou, China University of Mining and Technology Press in June 2022 (Version I) and its Theory and Application of Warm Nuclear Fusion Accompanied by Fossil Fuel Burning, America, China Culture Publishing House in July 2025 (Version II), which will not be elaborated here.

It can be understood that to facilitate mounting and maintenance of the above combined burning torch 3, the combined burning torch 3 is mounted on a sliding rail 5. The burning torch is driven by a speed reducer 7 to slide on the sliding rail, and the sliding rail 5 is provided with an electric controller 8 for controlling the warm nuclear fusion and pulverized coal combined burning torch 3. The sliding rail 5 is mounted on a supporting frame 6, and the supporting frame 6 is fixed on the elbow 12 through a connection flange.

In a preferred implementation, a top of the cyclone coal collector 4 is connected to a side wall of an upper part of the elbow 12 through an exhaust gas conveying pipe; and the exhaust gas conveying pipe is provided with a variable-frequency induced draft fan 45. Specifically, the exhaust gas conveying pipe includes an exhaust gas lead-out pipe 44 and an exhaust gas guide pipe 43. The exhaust gas lead-out pipe 44 is directly connected to a top outlet of the cyclone coal collector. The exhaust gas guide pipe 43 is connected to the elbow 12, and the variable-frequency induced draft fan 45 is connected between the exhaust gas lead-out pipe 44 and the exhaust gas guide pipe 43. The cyclone coal collector can generate exhaust gas during concentration of the pulverized coal, and the exhaust gas passes through the exhaust gas lead-out pipe 44 and the exhaust gas guide pipe 43 and is then conveyed to the elbow 12 for recycling after being pressurized by the variable-frequency induced draft fan 45. Due to the recycling design, low-concentration pulverized coal air flow after cyclone separation returns to a primary burning system again, so that the pulverized coal utilization rate is increased, and a carbon content of flying ash is reduced. Furthermore, the variable-frequency induced draft fan 45 can dynamically adjust a return amount of the exhaust gas according to a system load and keep an optimal burning state within a load range of 30% to 100%. This also avoids energy waste and environmental pollution that are caused by direct emission of the exhaust gas, and the overall energy conservation rate of the system is increased.

In a preferred implementation, a sealed coal unloading valve 46, a pulverized coal falling pipe 47, and a pulverized coal ejector 48 are connected between the bottom outlet of the cyclone coal collector 4 and the dense-phase pulverized coal guide pipe 42 in sequence. The sealed coal unloading valve 46 effectively prevents the high-pressure air from leaking into the cyclone coal collector 4 and can control a falling amount of the dense-phase pulverized coal and ensure the pulverized coal separation efficiency and stability. The pulverized coal ejector 48 uses the Venturi effect to implement powerless conveying of the dense-phase pulverized coal, thus reducing the energy consumption of the system. Due to a multi-stage sealing design, the air leakage rate in the pulverized coal conveying process is controlled within 0.5%, thus ensuring the burning stability. Furthermore, a modularized design is convenient for maintenance and replacement, so that the replacement time for a single component is shortened.

In a preferred implementation, an exterior of the grounding electrode 34 is cylindrical, and an interior of the grounding electrode 34 is tapered and transitioned from a cylindrical shape into a plum blossom shape in a wind direction. The plurality of electrode tips 331 are located inside a plurality of accommodating cavities of the plum blossom shape in a one-to-one correspondence manner. The design on an inner wall of the plum blossom shape matches shapes of the electrode tips 331 to form a multi-region electric field enhanced effect, so that the plasma generation efficiency is improved. Furthermore, the tapered transition structure guides the plasma arc to be gathered towards a center, so that local high temperature is avoided while the energy density is increased. Furthermore, an end portion of the central wind-coal pipe 32 close to the electrode tips 331 is flared. The flared design reduces the resistance to the pulverized coal air flow. Each electrode tip 331 is in a shape with a thin front part and a thick rear part, thus reducing energy concentration at a root part of an arc and prolonging the service life of the electrode.

Specifically, a spacing distance between the electrode tips 331 and an inner wall of the grounding electrode 34 is 3 to 15 mm and gradually shortens forwards. A distance between the electrode tips 331 and the central wind-coal pipe 32 is 3 to 15 mm, which gradually prolongs forwards. Each electrode tip 331 is tower-shaped, which has a thin front part and a thick rear part, so as to facilitate the formation of the sliding plasma arc. The lifespan of the electrode is greatly prolonged to 3000 to 8500 hours. Meanwhile, this ensures that the air speed of the plasma carrier is within a range of 15 to 35 m/s, which implements quick and stable ignition.

In a preferred implementation, a front end of the central wind-coal pipe 32 is connected to the blunt cone 37. An outer diameter of the blunt cone 37 is consistent with an outer diameter of the central wind-coal pipe 32. A pointed end of the blunt cone is opposite to an axis of the central wind-coal pipe 32. The blunt cone 37 is arranged at the front end of the central wind-coal pipe 32, which can scatter the dense-phase pulverized coal fed by the central wind-coal pipe 32 and annularly and circumferentially diffuse the dense-phase pulverized coal, so as to feed the pulverized coal into an arc region to implement quick ignition.

Specifically, the blunt cone 37 is fixed at an end portion of the central wind-coal pipe 32 through a supporting strip 371. Two supporting strips 371 are preferably provided, which are fixed on two sides of the blunt cone 37 in a transverse zygomorphy manner. One end of each supporting strip 371 is fixed at the end portion of the central wind-coal pipe 32, so that it has little disturbance on the air flow while ensuring the structural strength.

In a preferred implementation, a plurality of cyclone blades 38 are respectively arranged on an inner wall of the flame stabilization pipe 36 and an inner wall of the central wind-coal pipe 32 that is close to the electrode tips 331 in circumferential directions of the flame stabilization pipe 36 and the central wind-coal pipe 32. The cyclone blades 38 are made of a wear-resistant material. Thus, the air flow helically moves and has a long flow path, which improves the pulverized coal and air mixing intensity, thus improving the burning efficiency and implementing stable burning.

In a preferred implementation, a plurality of supporting spokes 341 are uniformly distributed on an outer wall of the grounding electrode 34 in a circumferential direction of the grounding electrode 34; and one end of the flame stabilization pipe 36 is fixed on the supporting spokes 341 to support and fix the flame stabilization pipe 36 to cause the flame stabilization pipe 36 to be uniformly stressed and have a stable structure.

In a preferred implementation, a cable junction box 39 is arranged at one end of the outer sleeve 31 that is away from the grounding electrode 34. Two glass observation holes 391 are formed in an outer end surface of the cable junction box 39. High-temperature-resistant borosilicate glass is used, which can bear a temperature of 200° C. or above to ensure long-time stable observation. This implements all-round observation on a working state of the electrode and a pulverized coal conveying situation and is convenient for fault diagnosis. A cable outlet sealing sleeve 392 is arranged on an annular side surface of the cable junction box 39. The cable outlet sealing sleeve 392 is convenient for cable connection, and a sealed design implements waterproofing and dustproofing, making it applicable to a wet and dusty environment of a power plant.

In a preferred implementation, an outer wall of the outer sleeve 31 is wrapped with a wear-resistant protective layer 311 which is preferably a ceramic composite coating. This improves the wear resistance, thus prolonging the service life of the outer sleeve 31. The central wind-coal pipe 32 is wrapped with a thermal insulation layer 321 to reduce temperature loss and be conductive for ignition. The central wind-coal pipe 32 is a composite steel pipe with a ceramic inner liner and good wear resistance.

In a specific embodiment, dilute-phase pulverized coal with 0.2 kg/kg and 18 m/s is fed into the wind-coal pipe 2. The cyclone coal collector 4 delivers concentrated pulverized coal into the pulverized coal falling pipe through the sealed coal unloading valve 46, and then the concentrated pulverized coal enters the pulverized coal ejector 48. High-pressure air that is generated by the high-pressure fan 9 and has a pressure of 0.3 to 0.8 MPa is ejected into the dense-phase pulverized coal guide pipe 42. In this case, dense-phase pulverized coal with a coal-to-wind ratio of 0.4 to 0.8 kg/kg, 15 to 20 m/s, and 40 to 100 kg/h is fed into the central wind-coal pipe 32 of the warm nuclear fusion and pulverized coal combined burning torch 3 along with the high-pressure air and is sprayed out. The pulverized coal enters, in a dispersed manner through the blunt cone 37, a sliding plasma arc region that has a low temperature of 150 to 300° C. After the pulverized coal is ignited, the fire gradually grows. The flames successively ignite the dilute- and dense-phase stage-by-stage ignition tube 11 inside first to fifth stages of the multi-stage pulverized coal burner 1, thus ensuring ignition and burning stabilization of the entire pulverized coal entering a boiler.

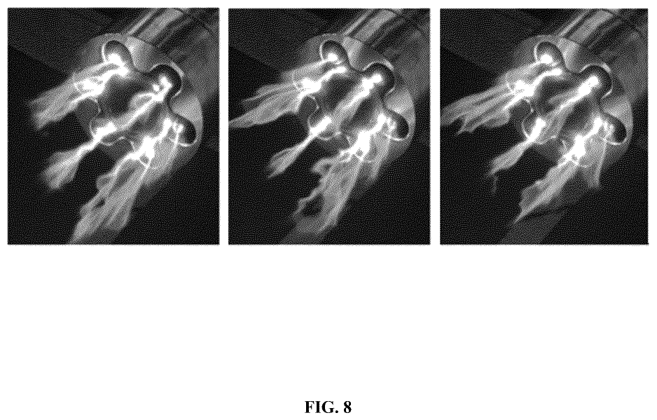

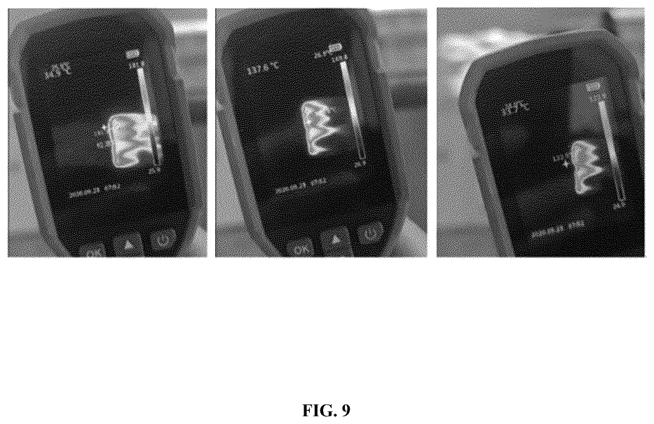

FIG. 8 and FIG. 9 show pictures of plasma discharging of a 12 KW warm nuclear fusion and pulverized coal combined burning torch 3 at different moments, and FIG. 9 shows infrared imaging pictures of plasma discharging of a 12 KW warm nuclear fusion and pulverized coal combined burning torch 3 at different moments. It can be seen from the figures that the temperature of the sliding plasma arc region is generally 30 to 200° C.

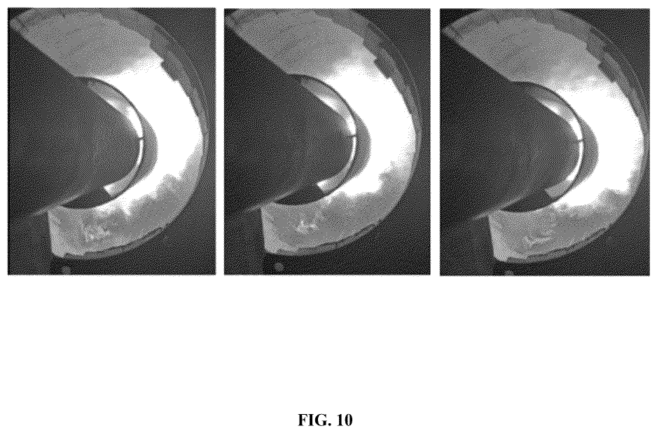

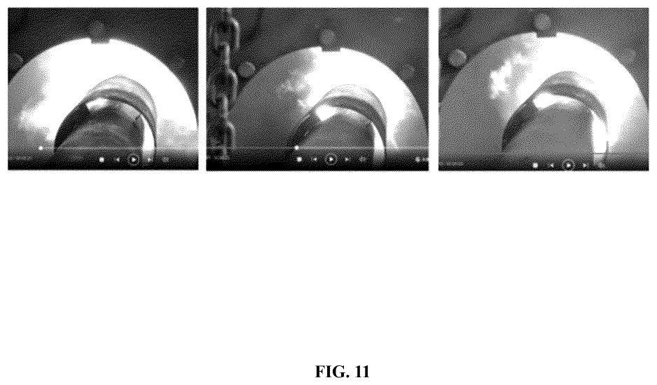

FIG. 10 and FIG. 11 shows pictures of 4500 kCal pulverized bituminous coal with 60 kg/kg at different moments of ignition, and FIG. 11 shows pictures of 3500 kCal pulverized lignite with 60 kg/kg at different moments of ignition. According to FIG. 10 and FIG. 11, ignition and burning stabilization of the pulverized coal by the sliding plasma arc at a low temperature of 30 to 200° C.

The embodiments of the present disclosure integrate three functions, i.e. ignition, burning stabilization, and energy conservation, and can cause a boiler load to operate at 15% to 100% and implement all-time all-weather peak shaving, burning stabilization, and ignition, accompanied by burning, and differences between the embodiments and the burner of the existing art are shown in Table I below:

TABLE I

| | Energy-saving | | |
|---|---|---|---|
| | burning stabilization | | |
| | torch of the present | | |
| | disclosure | Arc plasma ignition | Tiny-oil ignition |
| Ignition source | High-frequency | Direct current plasma | Gasification tiny-oil |
| | alternating current | arc | gun |
| | sliding arc | | |
| Application | Ignition, low-load | Ignition, low-load | Ignition, low-load |
| characteristic | burning stabilization, | burning stabilization | burning stabilization |
| | quick load increase, | | |
| | energy conservation | | |
| | and carbon reduction, | | |
| | and reduction of | | |
| | coking of ignited | | |
| | pulverized coal | | |
| | burner | | |
| Characteristic of | High-frequency, | Direct current, | Oil flame air flow |
| ignition source | alternating current, | low-voltage, high | works with |
| | high-voltage, low | current, and | pulverized coal |
| | current, high-voltage | high-temperature air | particles to |
| | electric field attracts | flow works with | implement ignition |
| | pulverized coal | pulverized coal | |
| | particles to move, | particles to | |
| | and works with the | implement ignition | |
| | pulverized coal | | |
| | particles to | | |
| | implement ignition | | |
| Energy consumption | 15 KW/h | 110 KW/h | 120 Kg/h |
| of single corner | | | |
| Shaving operation | 3000 h | 3000 h | 3000 h |
| time | | | |
| Energy consumption | Standard | Year-on-year | Year-on-year |
| comparison of single | | increase: 285000 | increase: 360000 Kg |
| corner | | KWh | |
| The power | The power | No reduction | No reduction |
| generation coal | generation coal | | |
| consumption is | consumption is | | |
| reduced after all | reduced by 2% | | |
| burners are modified | | | |
| Applicability of coal | All coal types | Bituminous coal, | All coal types |
| | | meagre coal | |
| Electrode cooling | Low current | High current | Atomized air cooling |
| | operation, no water | operation, high-flow | |
| | cooling | water cooling | |
| Electricity-to-heat | 100% | About 75% | |
| conversion rate | | | |
| Lifespan of electrode | 8000 h | 80-100 h | 3000 h |
| Spare parts | Very few | Negative and positive | Atomization nozzle |
| | | electrodes | |
| Reliability analysis | There is no risk, and | There is a risk of | Oil is not burnt |
| | operation of | water leakage in the | completely, and |
| | subsequent | electrode, and | operation of |
| | equipment such as | slag-bonding inside | subsequent |
| | denitration, air | the burner and | equipment such as |
| | pre-heater, electric | burning loss of the | denitration, air |
| | precipitation, and | burner may be | pre-heater, electric |
| | desulfurization will | caused | precipitation, and |
| | not be affected | | desulfurization will |
| | | | be affected |
| Investment cost | High | High | Low |

Moreover, unless otherwise explicitly defined or limited, in the embodiments of the present disclosure, the terms “mount” and “connect” shall be interpreted broadly. For instance, “connect” may refer to either detachable or non-detachable connection, direct connection, or indirect connection via an intermediate medium. If directional terms such as “upper,” “lower,” “left,” “right,” “inner,” “outer,” and “side” are used, they refer only to the orientations shown in the accompanying drawings or conventional placement orientations during product use. These terms are merely intended for clear description of the present disclosure and do not indicate or imply that a specified device or element needs to have a particular orientation and be constructed and operated in the particular orientation, so that these terms are not construed as limiting the present disclosure. In addition, the terms “first”, “second”, and the like are only for the purpose of distinguishing, and may not be understood as indicating or implying the relative importance. “Plurality” refers to at least two. In the embodiments of the present disclosure, relative positional relationships such as being parallel, being perpendicular, and being aligned mentioned are all defined relative to a current technical level, rather than absolutely strict limitation. Minor errors are permitted, allowing for being approximately parallel, being approximately perpendicular, being approximately aligned, and the like. For example, when A is parallel to B, it means that A and B are parallel or approximately parallel, with an angle between A and B ranging from 0 to 10 degrees.

The foregoing embodiments are merely some embodiments and implementations of the present disclosure, and are not intended to limit the protection scope of the present disclosure. Without conflicts, the embodiments of the present disclosure and features in the embodiments can be combined with each other. Arbitrary combination of the features in different embodiments also falls within the protection scope of the present disclosure. Changes or replacements that any person skilled in the art can easily think of within the technical range disclosed in the present disclosure all fall within the protection scope of the present disclosure.

What is claimed is:

1. An ignition, burning stabilization, and energy conservation integrated warm nuclear fusion and pulverized coal combined burning system, comprising a multi-stage pulverized coal burner, a wind-coal pipe, a combined burning torch, and a cyclone coal collector, wherein
the multi-stage pulverized coal burner comprises a stage-by-stage ignition tube and an elbow connected to a rear end of the stage-by-stage ignition tube; the wind-coal pipe is connected to another end of the elbow, and a coal taking opening is formed in one side of the wind-coal pipe;
an inlet of the cyclone coal collector is connected to the coal taking opening through a pulverized coal and air flow introduction pipe, and a bottom outlet of the cyclone coal collector is connected to the combined burning torch through a dense-phase pulverized coal guide pipe;
the combined burning torch comprises an outer sleeve, a central wind-coal pipe, a multi-phase electrode combination, a grounding electrode, and a high-pressure air supply pipe; a front end of the outer sleeve is fixedly connected to the grounding electrode; the central wind-coal pipe is threaded into the outer sleeve and the grounding electrode in sequence, and a rear end of the central wind-coal pipe is connected to the high-pressure air supply pipe and the dense-phase pulverized coal guide pipe; the multi-phase electrode combination is equally threaded between the central wind-coal pipe and the outer sleeve and is connected to a multi-phase alternating current plasma power source, and a plurality of electrode tips of the multi-phase electrode combination are distributed inside the grounding electrode in an equal spacing manner; and a front end of the grounding electrode is connected to the stage-by-stage ignition tube through a flame stabilization pipe.

2. The ignition, burning stabilization, and energy conservation integrated warm nuclear fusion and pulverized coal combined burning system according to claim 1, wherein a top of the cyclone coal collector is connected to a side wall of an upper part of the elbow through an exhaust gas conveying pipe; and the exhaust gas conveying pipe is provided with a variable-frequency induced draft fan.

3. The ignition, burning stabilization, and energy conservation integrated warm nuclear fusion and pulverized coal combined burning system according to claim 1, wherein a sealed coal unloading valve, a pulverized coal falling pipe, and a pulverized coal ejector are connected between the bottom outlet of the cyclone coal collector and the dense-phase pulverized coal guide pipe in sequence.

4. The ignition, burning stabilization, and energy conservation integrated warm nuclear fusion and pulverized coal combined burning system according to claim 1, wherein an exterior of the grounding electrode is cylindrical, and an interior of the grounding electrode is tapered and transitioned from a cylindrical shape into a plum blossom shape in a wind direction; the plurality of electrode tips are located inside a plurality of accommodating cavities of the plum blossom shape in a one-to-one correspondence manner; an end portion of the central wind-coal pipe close to the electrode tips is flared; and each electrode head is in a shape with a thin front part and a thick rear part.

5. The ignition, burning stabilization, and energy conservation integrated warm nuclear fusion and pulverized coal combined burning system according to claim 4, wherein a spacing distance between the electrode tips and an inner wall of the grounding electrode, and a spacing distance between the electrode tips and the central wind-coal pipe are respectively 3 to 15 mm; and an air speed of plasma carrier air is 15 to 35 m/s.

6. The ignition, burning stabilization, and energy conservation integrated warm nuclear fusion and pulverized coal combined burning system according to claim 1, wherein a front end of the central wind-coal pipe is connected to a blunt cone; an outer diameter of the blunt cone is consistent with an outer diameter of the central wind-coal pipe; and a pointed end of the blunt cone is opposite to an axis of the central wind-coal pipe.

7. The ignition, burning stabilization, and energy conservation integrated warm nuclear fusion and pulverized coal combined burning system according to claim 6, wherein the blunt cone is fixed at an end portion of the central wind-coal pipe through a supporting strip.

8. The ignition, burning stabilization, and energy conservation integrated warm nuclear fusion and pulverized coal combined burning system according to claim 1, wherein a plurality of cyclone blades are respectively arranged on an inner wall of the flame stabilization pipe and an inner wall of the central wind-coal pipe that is close to the electrode tips in circumferential directions of the flame stabilization pipe and the central wind-coal pipe.

9. The ignition, burning stabilization, and energy conservation integrated warm nuclear fusion and pulverized coal combined burning system according to claim 8, wherein a plurality of supporting spokes are uniformly distributed on an outer wall of the grounding electrode in a circumferential direction of the grounding electrode; and one end of the flame stabilization pipe is fixed on the supporting spokes.

10. The ignition, burning stabilization, and energy conservation integrated warm nuclear fusion and pulverized coal combined burning system according to claim 1, wherein a cable junction box is arranged at one end of the outer sleeve that is away from the grounding electrode two glass observation holes are formed in an outer end surface of the cable junction box; and a cable outlet sealing sleeve is arranged on an annular side surface of the cable junction box.
